(19) United States
(12) Patent Application Publication
(10) Pub. No.: US 2019/0266574 A1
(43) Pub. Date: Aug. 29, 2019

(54) SYSTEM AND MOBILE COMPUTING DEVICE APPLICATION FOR SELECTING TATTOOS AND SCHEDULING ONLINE APPOINTMENTS

(71) Applicant: Shannon Marsiglia, Chandler, AZ (US)

(72) Inventor: Shannon Marsiglia, Chandler, AZ (US)

(21) Appl. No.: 16/285,675

(22) Filed: Feb. 26, 2019

Related U.S. Application Data
(60) Provisional application No. 62/635,959, filed on Feb. 27, 2018.

(51) Int. Cl. G06Q 10/10; G06Q 30/06; H04L 29/08

(52) U.S. Cl. CPC G06Q 10/1095; G06Q 30/0603; G06Q 50/01; G06Q 30/0641; H04L 67/26; G06Q 30/0633

(57) ABSTRACT

A system and mobile computing device software application provide an online electronic gallery and scheduling tool through a user interface. The user interface may access a database of tattoo design images, which may be presented to a potential client, using flash software. The user may select and inspect potential designs. Once the user is ready, the user confirms wanting a selected tattoo design through the user interface. In some embodiments, tattoo artists may be selectable which may trigger a gallery of designs associated with respective artists. A user may select an artist, one of the artist's designs, and schedule an appointment with the artists for the selected design through the user interface.

### CROSS-REFERENCE TO RELATED APPLICATIONS

This application claims benefit under 35 U.S.C. § 119(e) of U.S. Provisional Application having Ser. No. 62/635,959 filed Feb. 27, 2018, which is hereby incorporated by reference herein in its entirety.

### BACKGROUND

The embodiments herein relate generally to e-commerce systems and more particularly, to systems and mobile computing device applications for selecting tattoos and scheduling online appointments.

The tattoo industry is increasingly popular and there are many potential customers who wish to set an appointment but are hesitant to do so without being committed to the experience. Traditionally, the field of tattooing requires the individual to physically visit an artist and browse previous work captured in pictures within a binder or hung on the parlor walls. There may be a big difference between conceptually wanting a tattoo and committing to a specific design. As a result, many potential clients that actually visit a shop may be merely window browsing because they do no want to be rushed into what is a potentially a permanent decision. Half committed clients may be distracting for the parlor and artists who have actual clients getting tattoos while the undecided client has questions.

Embodiments of the invention improve the process by providing a specific solution and unconventional step to the field of tattooing.

### SUMMARY

In one aspect of the subject technology, a computer program product for selecting tattoos and scheduling online appoints for selected tattoos is disclosed. The computer program product comprises a non-transitory computer readable storage medium having computer readable program code embodied therewith. The computer readable program code is configured, when executed by a processing unit, to: generate a user interface on the electronic display of a user's computing device; store a flash based selectable tattoo design images in a database; open an electronic gallery of selectable tattoo designs displayed using flash software on the user interface; receive a confirmation from a user of a selected tattoo design from the electronic gallery; and schedule an appointment for the user to have the selected tattoo design tattooed to their person. In another aspect of the subject technology, a method for selecting tattoos and scheduling online appoints for selected tattoos is disclosed. The method comprises generating a user interface on the electronic display of a user's computing device; storing a flash based selectable tattoo design images in a database; opening an electronic gallery of selectable tattoo designs displayed using flash software on the user interface; receiving a confirmation from a user of a selected tattoo design from the electronic gallery; and scheduling an appointment for the user to have the selected tattoo design tattooed to their person

### BRIEF DESCRIPTION OF THE FIGURES

The detailed description of some embodiments of the invention is made below with reference to the accompanying figures, wherein like numerals represent corresponding parts of the figures.

FIG. 1 is a flowchart of a method for calibrating images on an electronic display in accordance with an embodiment of the subject technology.

FIG. 2 is a block diagram of a computing device according to embodiments of the subject technology.

### DETAILED DESCRIPTION OF CERTAIN EMBODIMENTS

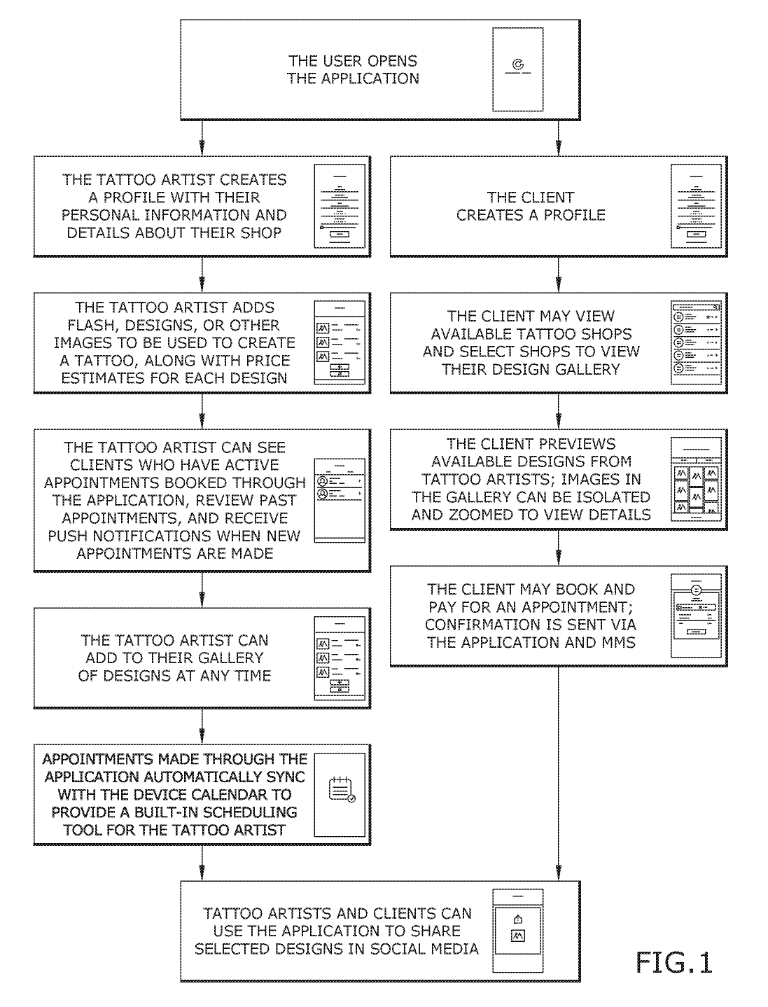

Broadly, embodiments of the subject technology provide a system and method of generating a user interface in a computing device which provides an online selection of tattoo designs and appointment scheduling for a tattoo. Referring now to FIG. 1, a method for online selection of tattoos and scheduling appointments is shown according to an exemplary embodiment.

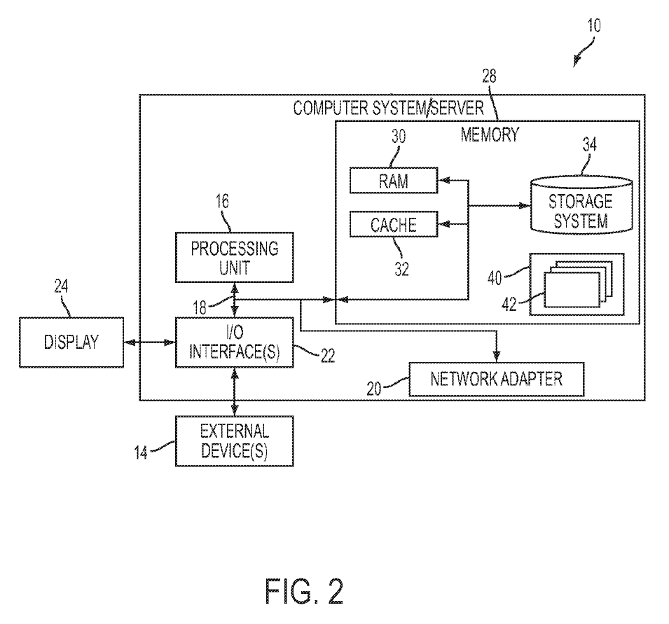

Referring to FIG. 1, a method 10 for calibrating images on an electronic display of an electronic display device is shown according to an exemplary embodiment. The method includes generating a user interface (UI) on the electronic display of a user's computing device. In practice, a user will open up the application from a device such as a smart phone, smart wearable device, or computer system (which are discussed in more detain in FIG. 2). Some steps of the method are pre-set before the user opens the application. For example, generally one or more tattoo artists create a portfolio of tattoo designs. Each artist may create a profile. Each artist's portfolio may be stored in electronic files associated with respective artists' profile within a database. In some embodiments, the artist may provide a price estimate for each design. In an exemplary embodiment, the stored tattoo designs may be stored under an Adobe® flash-based format.

From the user client side, the user may create a profile. The user may be provided through the UI one or more tattoo shops from which the user may select and browse through the shop's available design gallery. Through the UI, the user may open an electronic gallery of selectable tattoo designs displayed using flash software for the user's preview. The user may be able to zoom in on designs to view details. Once the user client has selected a design and confirmed wanting it tattooed to their person, the UI may present the user with an online scheduler to confirm an appointment. In some embodiments, the user may receive an electronic confirmation message) to their computing device.

From the tattoo artist user side, an artist may receive a confirmation of a selected tattoo design from the electronic gallery. The tattoo artist may be presented a page in the UI from which he or she can see clients who have active appointments booked through the application (present appointments, future appointments, and past appointments with the artwork performed). In some embodiments, the application may generate a push notification sent to the artist's UI which may be triggered when new appointments are confirmed. Some embodiments may automatically calendar a confirmed appointment by synchronizing the appointment with the artist's electronic calendar in their computing device.

From both or either of the client user's UI or the artist's UI, tattoos performed may be captured as an electronic image and uploaded to a social media account associated with the computing device.

Referring now to FIG. 2, a schematic of an example of a computer system/server 10 is shown. The computer system/server 10 is shown in the form of a general-purpose computing device. The components of the computer system/server 10 may include, but are not limited to, one or more processors or processing units 16, a system memory 28, and a bus 18 that couples various system components including the system memory 28 to the processor 16.

In some embodiments, the computer system/server 10 may be a cloud computing node connected to a cloud computing network (not shown). The computer system/server 10 may be for example, personal computer systems, tablet devices, mobile telephone devices, server computer systems, handheld or laptop devices, multiprocessor systems, microprocessor-based systems, set top boxes, programmable consumer electronics, network PCs, and distributed cloud computing environments that include any of the above systems or devices, and the like, which may be interfaced with by a client user or a tattoo artists user as described above. The computer system/server 10 may be described in the general context of computer system executable instructions, such as program modules, being executed by a computer system (described for example, below). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described above including for example, generating the user interfaces from both the client side and the tattoo artist side, storing, displaying, and confirming selection of a tattoo design, and scheduling online appointments.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for selecting tattoos and scheduling online appoints for selected tattoos, the computer program product comprising a non-transitory computer readable storage medium having computer readable program code embodied therewith, the computer readable program code being configured, when executed by a processing unit, to:
generate a user interface on the electronic display of a user's computing device;
store a flash based selectable tattoo design images in a database;
open an electronic gallery of selectable tattoo designs displayed using flash software on the user interface;
receive a confirmation from a user of a selected tattoo design from the electronic gallery; and
schedule an appointment for the user to have the selected tattoo design tattooed to their person.

2. The computer program product of claim 1, further comprising computer readable program code configured to:
organize the electronic gallery by tattoo designs associated with one or more tattoo artists; and
for a selected tattoo artist, display one or more of the selectable tattoo designs associated with the selected tattoo artist, wherein the scheduled appointment is automatically scheduled with the selected tattoo artist.

3. The computer program product of claim 2, further comprising computer readable program code configured to generate a push notification to a computing device of the selected tattoo artist.

4. The computer program product of claim 3, further comprising computer readable program code configured to automatically synchronize the scheduled appointment with an electronic calendar in the computing device of the selected tattoo artist.

5. The computer program product of claim 2, further comprising computer readable program code configured to upload an image of a completed tattoo on the user's person to a social media site associated with the user or associated with the selected tattoo artist.

6. A method for selecting tattoos and scheduling online appoints for selected tattoos, comprising:
generating a user interface on the electronic display of a user's computing device;
storing a flash based selectable tattoo design images in a database;
opening an electronic gallery of selectable tattoo designs displayed using flash software on the user interface;
receiving a confirmation from a user of a selected tattoo design from the electronic gallery; and
scheduling an appointment for the user to have the selected tattoo design tattooed to their person.

7. The method of claim 6, further comprising:
organizing the electronic gallery by tattoo designs associated with one or more tattoo artists; and
for a selected tattoo artist, displaying one or more of the selectable tattoo designs associated with the selected tattoo artist, wherein the scheduled appointment is automatically scheduled with the selected tattoo artist.

8. The method of claim 7, further comprising generating a push notification to a computing device of the selected tattoo artist.

9. The method of claim 7, further comprising automatically synchronizing the scheduled appointment with an electronic calendar in the computing device of the selected tattoo artist.

10. The method of claim 7, further comprising uploading an image of a completed tattoo on the user's person to a social media site associated with the user or associated with the selected tattoo artist.
